(19) United States
(12) Patent Application Publication
(10) Pub. No.: US 2025/0343462 A1
(43) Pub. Date: Nov. 6, 2025

(54) ELECTRIC DRIVE UNIT

(71) Applicant: American Axle & Manufacturing, Inc., Detroit, MI (US)

(72) Inventors: Austin R. GERDING, Shelby Township, MI (US); Michael Dennis WERTHMAN, Casco, MI (US); Eric Alan RIVETT, Macomb, MI (US); Paul J. VALENTE, Berkley, MI (US); James P. DOWNS, South Lyon, MI (US)

(21) Appl. No.: 18/880,134

(22) PCT Filed: Jun. 29, 2023
(86) PCT No.: PCT/US2023/026546

§ 371 Date: Dec. 30, 2024

Related U.S. Application Data
(60) Provisional application No. 63/357,058, filed on Jun. 30, 2022.

(51) Int. Cl. H02K 7/116; F16H 3/44; F16H 48/38

(52) U.S. Cl. CPC H02K 7/116; F16H 3/44; F16H 48/38

(57) ABSTRACT

An electric drive unit with an electric motor, an input pinion, which is driven by an output shaft of the electric motor about a first axis, a pair of first gears, each of which is meshed with the input pinion and rotatable about a respective second axis, a second gear, which is meshed with the first gears and rotatable about a third axis, a third gear, which is driven by the second gear about the third axis, a fourth gear, which is meshed with the third gear and rotatable about a fourth axis, and a differential having a differential input, which is rotatably coupled to the third gear, and a pair of differential outputs that are driven by the differential input and rotatable about the fourth axis. The first, second, third and fourth axes are parallel to one another. The third axis is offset from the first and second axes.

### CROSS-REFERENCE TO RELATED APPLICATIONS

This application claims the benefit of U.S. Provisional Patent Application No. 63/357,058 filed Jun. 30, 2022, and to PCT application number PCT/US2023/026546 filed Jun. 29, 2023, the disclosure of which is incorporated by reference as if fully set forth in detail herein.

### FIELD

The present disclosure relates to an electric drive unit.

### BACKGROUND

This section provides background information related to the present disclosure which is not necessarily prior art.

U.S. Pat. No. 11,293,534 discloses an electric drive module having a relatively compact transmission that is configured to provide a relatively high overall reduction ratio between the output shaft of an electric motor and the output of the transmission. While such a transmission is suitable for its intended purpose, there nevertheless remains a need in the art for relatively compact transmissions that provide a relatively high overall reduction ratio.

### SUMMARY

This section provides a general summary of the disclosure, and is not a comprehensive disclosure of its full scope or all of its features.

In one form, the present disclosure provides an electric drive unit that includes an electric motor, an input pinion, a pair of first reduction gears, a second reduction gear, a third reduction gear, a fourth reduction gear, and a differential assembly. The electric motor has a motor output shaft that is rotatable about a first rotational axis. The input pinion is driven by the motor output shaft about the first rotational axis. Each of the first reduction gears is meshingly engaged with the input pinion and is rotatable about a respective second rotational axis that is parallel to the first rotational axis. The second reduction gear is meshingly engaged with the first reduction gears and is rotatable about a third rotational axis that is parallel to an offset from the first and second rotational axes. The third reduction gear is driven by the second reduction gear about the third rotational axis. The fourth reduction gear is meshingly engaged with the third reduction gear and is rotatable about a fourth rotational axis that is parallel to the second and third rotational axes. The differential assembly has a differential input and a pair of differential outputs. The differential input is coupled to the third reduction gear for rotation therewith about the fourth rotational axis. Each of the differential outputs is driven by the differential input and is rotatable about the fourth rotational axis.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a perspective, partly sectioned view of an exemplary electric drive unit constructed in accordance with the teachings of the present disclosure;

FIG. 2 is a perspective view of a transmission of the electric drive unit of FIG. 1;

FIG. 3 is a partly sectioned elevation view of a second exemplary electric drive unit constructed in accordance with the teachings of the present disclosure;

FIG. 4 is a perspective view of a transmission of the electric drive unit of FIG. 3;

FIG. 5 is a perspective view of a portion of a third electric drive unit constructed in accordance with the teachings of the present disclosure;

FIG. 6 is a longitudinal section view of a portion of the electric drive unit of FIG. 5, the view depicting a sun gear of a planetary reduction in a first position;

FIG. 7 is a section view taken along the line 7-7 of FIG. 5; and

FIG. 8 is a view similar to that of FIG. 6 but depicting the sun gear of the planetary reduction in a second position.

Corresponding reference numerals indicate corresponding parts throughout the several views of the drawings.

### DETAILED DESCRIPTION

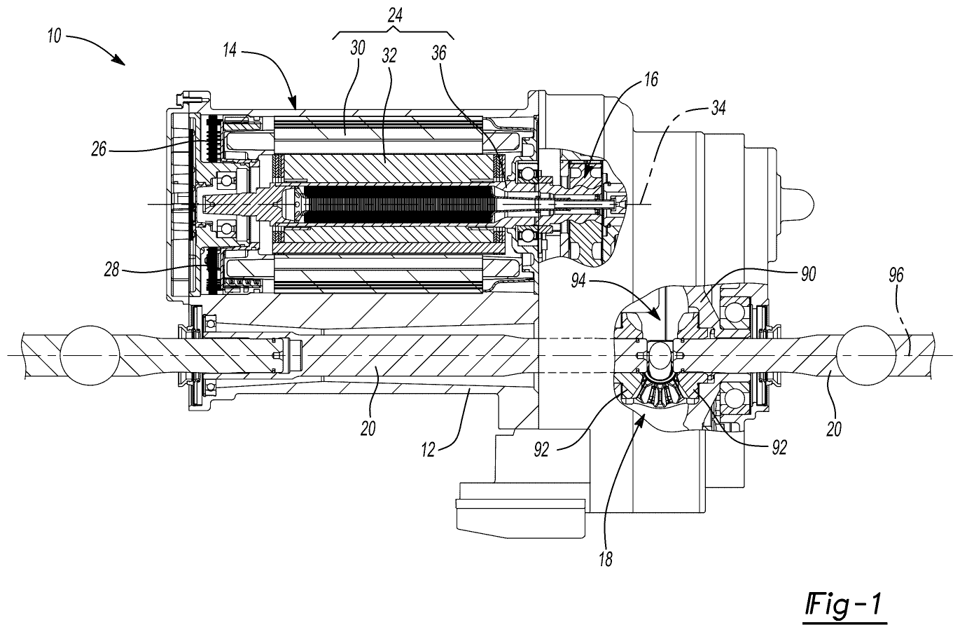

With reference to FIG. 1, an electric drive unit constructed in accordance with the teachings of the present disclosure is generally indicated by reference numeral 10. The electric drive unit 10 can include a housing 12, a motor assembly 14, a transmission 16, a differential 18 and a pair of output shafts 20. The motor assembly 14, the transmission 16 and the differential 18 are housed in the housing 12. The motor assembly 14 can include an electric motor 24 and a motor controller 26 having an inverter 28 that is directly mounted to the electric motor 24. The electric motor 24 can include a stator 30, which can be fixedly coupled to the housing 12, a rotor 32, which is received in the stator 30 and rotatable about a motor axis 34, and a motor output shaft 36 that is rotatable about the motor axis 34 with the rotor 32. The motor output shaft 36 can be fixedly coupled to the rotor 32.

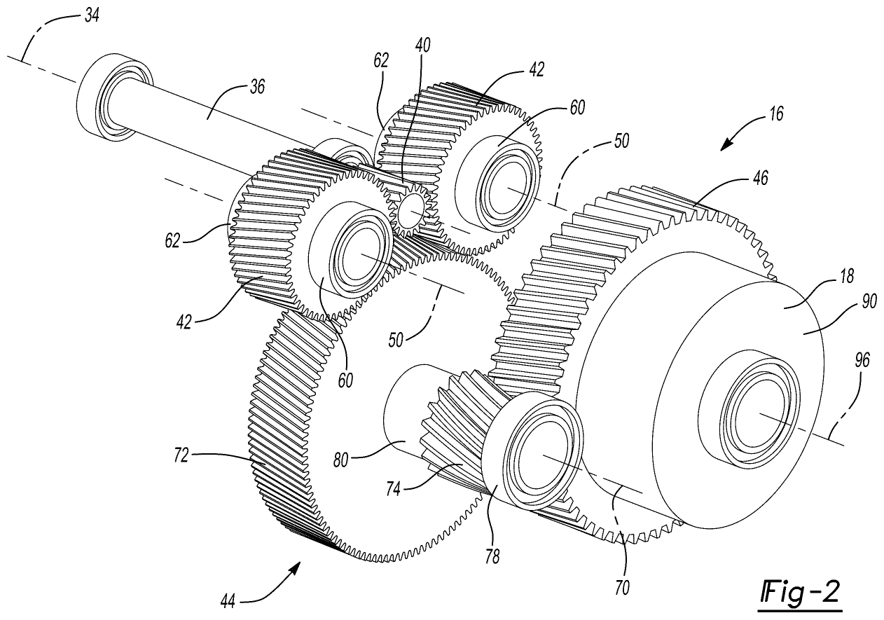

In FIG. 2, the transmission 16 is configured to transmit rotary power between the motor output shaft 36 and the differential 18. In the example shown, the transmission 16 includes an input pinion 40, a pair of first reduction gears 42, a compound gear 44, and an output gear 46. The input pinion 40 can be rotatably coupled to the motor output shaft 36 for rotation therewith about the motor axis 34. Optionally, the input pinion 40 can be unitarily and integrally formed with the motor output shaft 36. Each of the first reduction gears 42 can be meshed with the input pinion 40 and can be rotatable about a respective first intermediate axis 50. The first intermediate axes 50 are parallel to the motor axis 34 and are disposed in a first plane. Optionally, the motor axis 34 can be disposed in the first plane. Each of the first reduction gears 42 can be supported for rotation about an associated one of the first intermediate axes 50 by first and second bearings 60 and 62, respectively. The first and second bearings 60 and 62 can be any type of bearing and can be mounted to the housing 12 (FIG. 1) and to the shaft portions of the first reduction gears 42 in any desired manner. For example, the first and second bearings 60 and 62 can be tapered roller bearings having an outer bearing race, which is fixedly coupled to the housing 12 (FIG. 1), an inner bearing race, which is fixedly coupled to a shaft portion (not shown) of the first reduction gear 42, and a plurality of rollers that are received between the outer and inner bearing races. In the example shown, neither of the first and second bearings 60 and 62 is preloaded such that the rollers of each of the first and second bearings 60 and 62 are either in line-to-line contact with the outer and inner bearing races or there is some modicum of clearance between the rollers and at least one of the outer and inner bearing races. Alternatively, the first and second bearings 60 and 62 can be preloaded in an axial direction. It will be appreciated that other types of bearings could be employed for the first and second bearings 60 and 62, and that the first and second bearings 60 and 62 can be different types of bearings (e.g., one could be a type of ball bearing, such as a radial ball bearing or an angular contact ball bearing, and the other one could be a cylindrical roller bearing).

The compound gear 44 is rotatable relative to the housing 12 (FIG. 1) about a second intermediate axis 70 and includes a second reduction gear 72 and a third reduction gear 74. The second reduction gear 72 is meshingly engaged to the first reduction gears 42. The third reduction gear 74 is coupled to the second reduction gear 72 for rotation therewith about the second intermediate axis 70 and is meshingly engaged with the output gear 46. The compound gear 44 can be supported for rotation about the second intermediate axis 70 by a third bearing (not shown) and a fourth bearing 78. The third bearing and the fourth bearing 78 can be any type of bearing and can be mounted to the housing 12 (FIG. 1) and to a shaft portion 80 of the compound gear 44 in any desired manner. For example, the third bearing and the fourth bearing 78 can be tapered roller bearings having an outer bearing race, which is fixedly coupled to the housing 12 (FIG. 1), an inner bearing race, which is fixedly coupled to the shaft portion 80 of the compound gear 44, and a plurality of rollers that are received between the outer and inner bearing races. In the example shown, neither the third bearing nor the fourth bearing 80 is preloaded such that the rollers of each of the third and fourth bearings are either in line-to-line contact with the outer and inner bearing races or there is some modicum of clearance between the rollers and at least one of the outer and inner bearing races. Alternatively, the third and fourth bearings can be preloaded in an axial direction. It will be appreciated that other types of bearings could be employed for the third and fourth bearings, and that the third and fourth bearings can be different types of bearings (e.g., one could be a type of ball bearing, such as a radial ball bearing or an angular contact ball bearing, and the other one could be a cylindrical roller bearing).

In the example shown, each set of meshing gears in the transmission 16 (i.e., the input pinion 40 and the first reduction gears 42; the first and second reduction gears 42 and 44; the third reduction gear 74 and the output gear 46) are formed as helical gears, but it will be appreciated that other gear types, such as spur gears, could be employed for one of more of the sets of meshing gears in the transmission 16.

With reference to FIGS. 1 and 2, the differential 18 includes a differential input 90, a pair of differential outputs 92 and a speed differentiation mechanism 94. The differential input 90 can be coupled to the output gear 46 for rotation about an output axis 96 that can be parallel to the motor axis 34, the first intermediate axes 50 and the second intermediate axis 70. The differential outputs 92 can be rotatable about the output axis 96 relative to the differential input 90. The speed differentiation mechanism 94 is configured to transmit rotary power between the differential input 90 and the differential outputs 92 and to permit relative rotation between the differential outputs 92. In one form, the speed differentiation mechanism 94 could include a pair of friction clutches (not shown) that are disposed between the differential input 90 and an associated one of the differential outputs 92. In another form, the speed differentiation mechanism 94 could include differential gearing between the differential input 90 and the differential outputs 92. In the example provided, the differential input 90 is a differential carrier and the speed differentiation mechanism 94 includes differential gearing that is received in the differential carrier. The differential gearing can include a cross-pin, which can be fixedly coupled to the differential carrier and can intersect and be disposed perpendicular to the output axis 96, a pair of differential pinions which are rotatably mounted on the cross-pin, and a pair of side gears that can each be rotatable about the output axis 96 and meshingly engaged with differential pinions. In the example provided, each of the differential outputs 92 is an internally-splined hub segment that is unitarily and integrally formed on an associated one of the side gears.

The differential input 90 and the output gear 46 can be supported for rotation about the output axis 96 by a fifth bearing (not shown) and a sixth bearing 100. The fifth bearing and the sixth bearing 100 can be any type of bearing and can be mounted to the housing 12 (FIG. 1) and to one of the differential input 90 and the output gear 46 in any desired manner. For example, the fifth and sixth bearings can be tapered roller bearings having an outer bearing race, which is fixedly coupled to the housing 12 (FIG. 1), an inner bearing race, which is fixedly coupled to the differential carrier in the example provided, and a plurality of rollers that are received between the outer and inner bearing races. In the example shown, neither of the fifth and sixth bearings is preloaded such that the rollers of each of the fifth and sixth bearings are either in line-to-line contact with the outer and inner bearing races or there is some modicum of clearance between the rollers and at least one of the outer and inner bearing races. Alternatively, the fifth and sixth bearings can be preloaded in an axial direction. It will be appreciated that other types of bearings could be employed for the fifth and sixth bearings, and that the fifth and sixth bearings can be different types of bearings (e.g., one could be a type of ball bearing, such as a radial ball bearing or an angular contact ball bearing, and the other one could be a cylindrical roller bearing).

Each of the output shafts 20 is coupled with an associated one of the differential outputs 92 for rotation about the output axis 96.

It will be appreciated that a disconnect mechanism (not shown)

could optionally be integrated into the electric drive module 10. The disconnect mechanism is employed to selectively interrupt the transmission of rotary power between the electric motor 24 and one or both of the output shafts 20. Examples of suitable disconnect mechanisms are illustrated and described in commonly assigned U.S. Pat. Nos. 8,047,323, 8,469,854, 9,028,358, 9,079,495, 9,162,567 and 10,391,861.

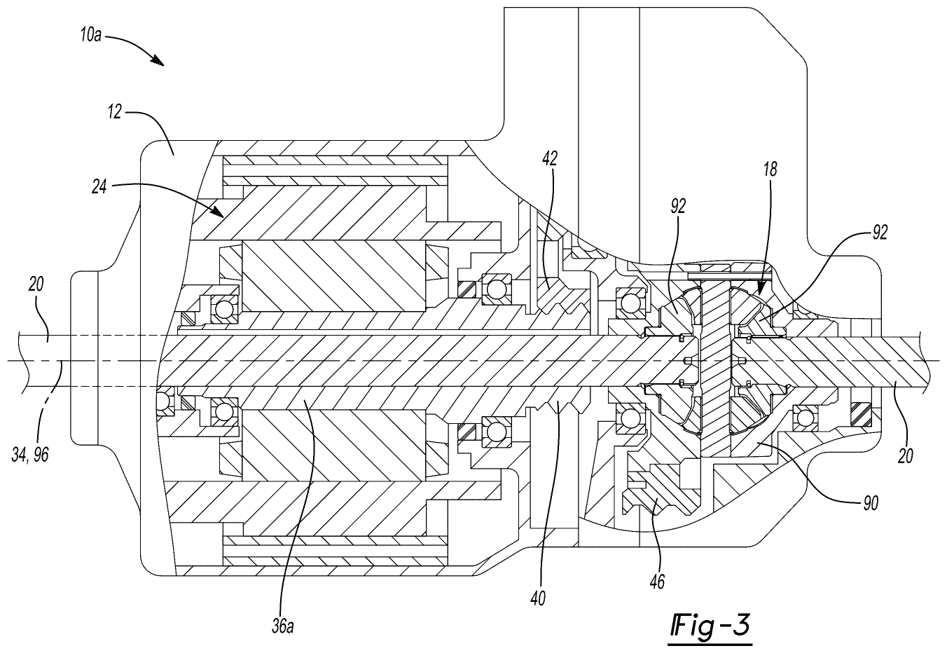

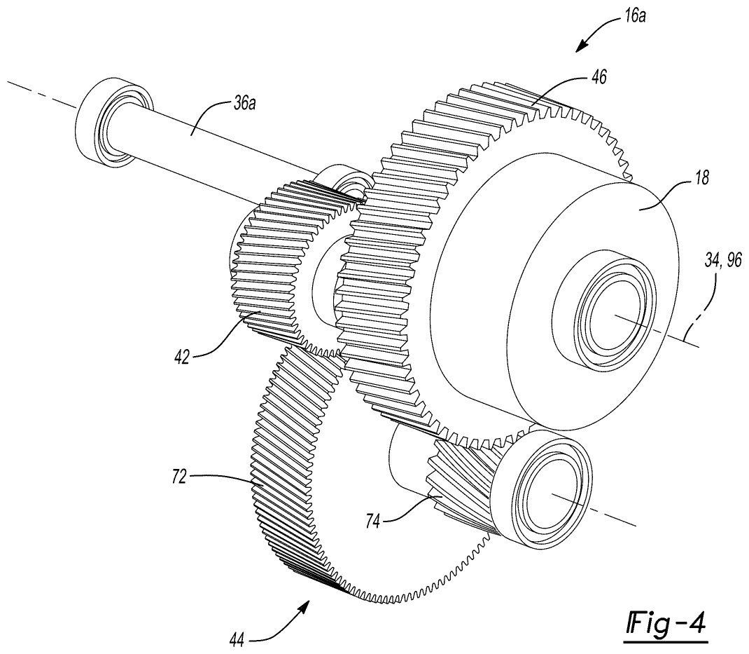

With reference to FIGS. 3 and 4, a second electric drive unit constructed in accordance with the teachings of the present disclosure is generally indicated by reference numeral 10a. The electric drive unit 10a is constructed in a manner that is identical to that of the electric drive unit 10 (FIG. 1) except that the output gear 46 is rotated about the third reduction gear 74 such that the output axis 96 is coincident with the motor axis 34, and the motor output shaft 36a is hollow so that the one of the output shafts 20 is received through the electric motor 24.

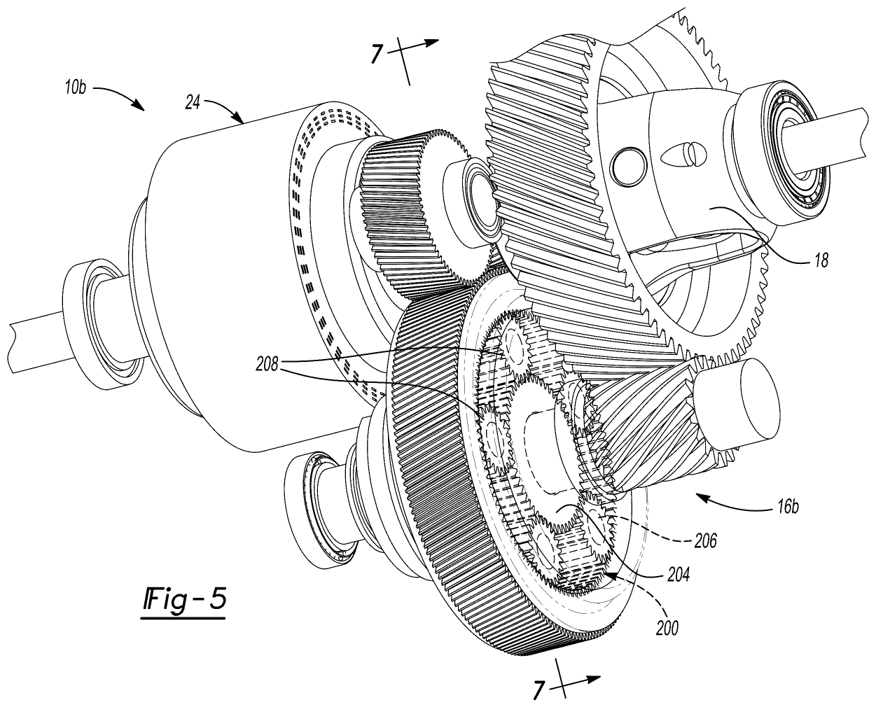

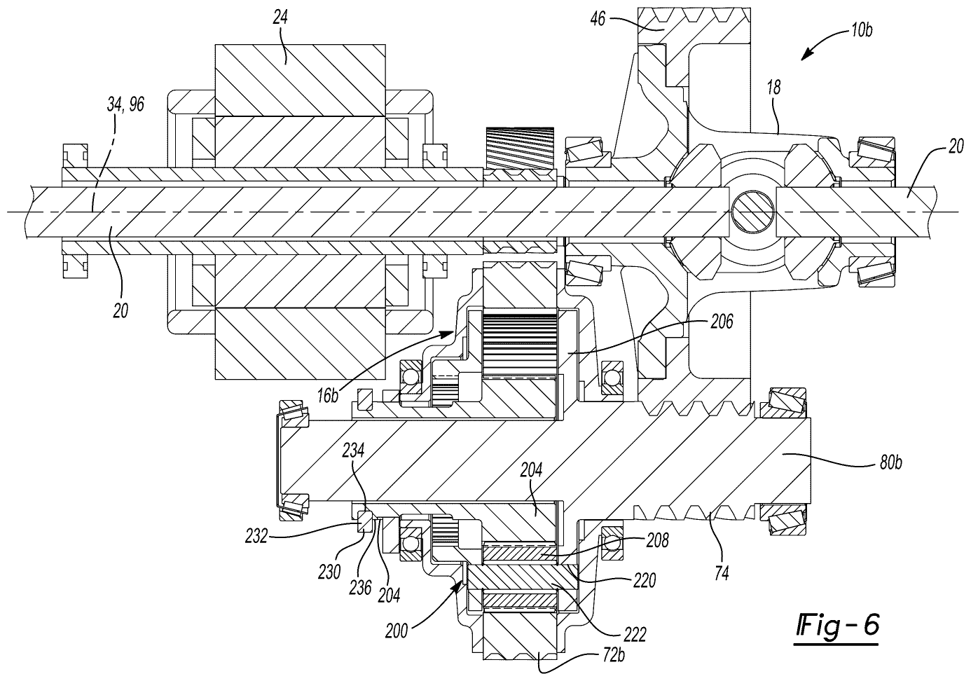

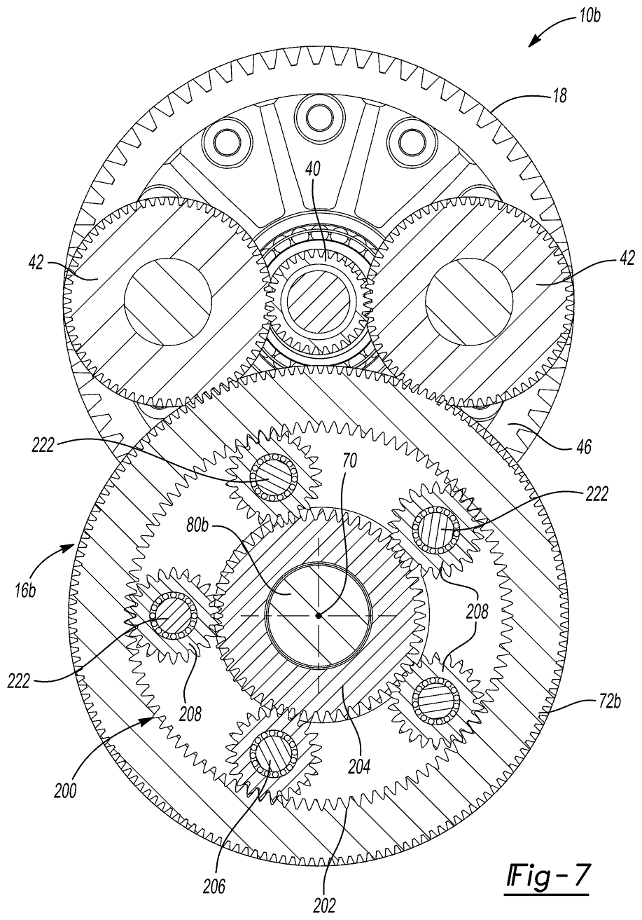

With reference to FIGS. 5-7, a portion of a third electric drive unit 10b constructed in accordance with the teachings of the present disclosure is illustrated. In the example illustrated, the electric motor 24 is situated so that it is coaxial with the differential 18, and the motor axis 34 and the output axis 96 are coincident. Additionally, the transmission 16b is a two-speed transmission that includes a planetary reduction 200 that is disposed between the second reduction gear 72b and the third reduction gear 74. The planetary reduction 200 includes a ring gear 202, a sun gear 204, a planet carrier 206, and a plurality of planet gears 208. The ring gear 202 is coupled to the second reduction gear 72b for rotation therewith and includes a plurality of internal gear teeth. In the example provided, the ring gear 202 and the second reduction gear 72a are fixedly coupled to one another (e.g., integrally and unitarily formed). The sun gear 204 is disposed concentrically about the shaft portion 80a and is rotatable on the shaft portion 80b as well as axially slidably disposed on the shaft portion 80a. In the example provided, the sun gear 204 defines a shaft opening that is mounted on a cylindrical segment of the shaft portion 80b. The shaft portion 80a can be rotatably coupled (e.g., fixedly coupled) to the third reduction gear 74 in any desired manner. The planet carrier 206 includes a carrier body 220 (FIG. 6) and a plurality of pins 222 (FIG. 7) that are fixedly coupled to the carrier body 220 and spaced circumferentially about the second intermediate axis 70. The carrier body 220 can be coupled to the shaft portion 80b for common rotation about the second intermediate axis 70. In the example provided, the carrier body 220 includes a first body member, which is fixedly coupled to (e.g., unitarily and integrally formed with) the shaft portion 80b and extends radially outwardly therefrom, and a second body member that has an annular shape and is spaced axially apart from the first body member along the second intermediate axis 70. The opposite axial ends of the pins 222 can be fixedly coupled to the first and second body members. Each of the planet gears 208 is rotatably disposed on a corresponding one of the pins 222 and is meshingly engaged to the ring gear 202 and the sun gear 204.

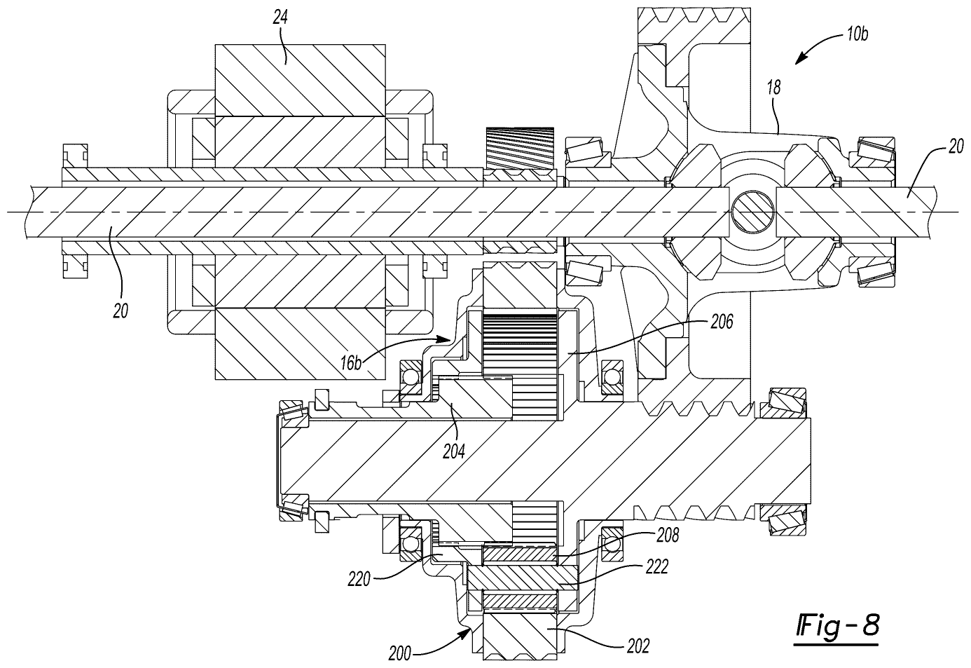

The sun gear 204 is axially movable along the second intermediate axis 70 between a first position, which is shown in FIG. 6, and a second position that is shown in FIG. 8. Placement of the sun gear 204 in the first position causes the planetary reduction 200 to perform a speed reduction and torque multiplication function between the second reduction gear 72a and the shaft portion 80a. Placement of the sun gear 204 in the second position rotationally locks the sun gear 204 to the planet carrier 206 and effectively inhibits relative rotation between the planet carrier 206, the sun gear 204 and the ring gear 202 so that the output of the planetary reduction 200 (i.e., the planet carrier 206 in the example provided) rotates at the same rotational speed as the input of the planetary reduction 200 (i.e., the ring gear 202 in the example provided).

Any type of actuator may be employed to control the movement of the sun gear 204 along the second intermediate axis 70. For example, a spring (not shown) could be employed to bias the sun gear 204 in a predetermined direction along the intermediate axis 70 toward either the first position or the second position. In the example provided, a shift fork 230 is provided having a pair of tines 232 that are received into an annular groove 234 that is formed about the circumference of a hub portion 236 of the sun gear 204. The shift fork 230 can be moved along the second intermediate axis 70 by any desired means, such as a solenoid, a pneumatic cylinder or a hydraulic cylinder.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electric drive unit comprising:
an electric motor having a motor output shaft that is rotatable about a first rotational axis;
an input pinion that is driven by the motor output shaft about the first rotational axis;
a pair of first reduction gears that are meshingly engaged with the input pinion, each of the first reduction gears being rotatable about a respective second rotational axis that is parallel to the first rotational axis;
a second reduction gear that is meshingly engaged with the first reduction gears, the second reduction gear being rotatable about a third rotational axis that is parallel to and offset from the first and second rotational axes;
a third reduction gear that is driven by the second reduction gear, the third reduction gear being rotatable about the third rotational axis;
a fourth reduction gear that is meshingly engaged with the third reduction gear, the fourth reduction gear being rotatable about a fourth rotational axis that is parallel to the second and third rotational axes; and
a differential assembly having a differential input and a pair of differential outputs, the differential input being coupled to the third reduction gear for rotation therewith about the fourth rotational axis, each of the differential outputs being driven by the differential input and being rotatable about the fourth rotational axis.

2. The electric drive unit of claim 1, further comprising a planetary reduction disposed between the second and third reduction gears, the planetary reduction having a planetary input, which is coupled to the second reduction gear for rotation therewith, and a planetary output, which is coupled to the third reduction gear for rotation therewith.

3. The electric drive unit of claim 2, wherein the planetary reduction is at least partly housed in the second reduction gear.

4. The electric drive unit of claim 3, wherein the planetary input is a ring gear that is fixedly coupled to the second reduction gear.

5. The electric drive unit of claim 4, wherein the ring gear and the second reduction gear are unitarily and integrally formed.

6. The electric drive unit of claim 2, wherein the planetary reduction is a two-speed reduction.

7. The electric drive unit of claim 6, wherein the planetary reduction includes a sun gear, a planet carrier and a plurality of planet gears, the planet carrier journally supporting each of the planet gears for rotation about a respective planet gear axis, each of the planet gears being meshingly engaged with the sun gear, wherein one of the planet carrier and the sun gear is axially movable along the third rotational axis between a first position, in which relative rotation is permitted between the planet carrier and the sun gear, and a second position in which relative rotation between the planet carrier and the sun gear is inhibited.

8. The electric drive unit of claim 2, wherein the first and fourth rotational axes are coincident.

9. The electric drive unit of claim 1, wherein the first and fourth rotational axes are coincident.

10. The electric drive unit of claim 1, further comprising an inverter that is directly mounted to the electric motor.
